(19) United States
(12) Patent Application Publication
(10) Pub. No.: US 2009/0282087 A1
(43) Pub. Date: Nov. 12, 2009

(54) AUTOMATICALLY CHANGING TAGS

(75) Inventors: Michael Muller, Medford, MA (US); Andrew L. Schirmer, Andover, MA (US); David A. Brooks, Providence, RI (US)

Correspondence Address: HAMILTON, BROOK, SMITH & REYNOLDS, 530 VIRGINIA ROAD, PO BOX 9133, CONCORD, MA, 01742-9133, US

(73) Assignee: INTERNATIONAL BUSINESS MACHINES CORPORATION, Armonk, NY (US)

(21) Appl. No.: 12/115,756

(22) Filed: May 6, 2008

(51) Int. Cl. G06F 17/30

(52) U.S. Cl. 707/201; 707/E17.01

(57) ABSTRACT

Time-style tags are provided. These user specified social tags automatically change as a function of time or triggering event. The invention tags include:
Expiring tags that disappear after a user-specified period of time;
Morphing tags that change their text after a user-specified period of time; and
Appearing tags that appear in view at or about a user-specified time. Respective text of a tag is user-specified.

### BACKGROUND

In a social-tagging system, tags can be used for many purposes. One purpose is to call attention to the items tagged, which can be done by using tags like “important”, “hot”, “review soon”, and so forth. This is essentially a time-related use—the tag “hot” may become irrelevant at some time after a resource is tagged as “hot.” Such tags may have value only for a while and then, and in fact become misleading, adding unnecessary noise to the tag system. To correct these problems in current tagging systems, the user must edit the tag properties of the tagged items and delete or rename the out-of-date tags.

### BRIEF SUMMARY

The present invention provides a solution to the foregoing problems. In particular, the present invention provides tags that automatically change over time, and further enables additional uses for time-style tags.

In embodiments of the invention these new types of tags include:

Expiring (disappearing) tags that disappear after a user specified period of time;

Morphing tags that change their text after a user specified period of time; and

Appearing tags that appear in view after a user specified period of time. In each case, respective text of the tags is user-defined and the tags change after a user specified period (interval) of time, at a user-specified date/time or after a triggering event and the like. As such, the present invention tags are time sensitive, are time dependent or otherwise operate as a function of time as specified by the user.

### BRIEF DESCRIPTION OF THE SEVERAL VIEWS OF THE DRAWINGS

The foregoing will be apparent from the following more particular description of example embodiments of the invention, as illustrated in the accompanying drawings in which like reference characters refer to the same parts throughout the different views. The drawings are not necessarily to scale, emphasis instead being placed upon illustrating embodiments of the present invention.

FIG. 1 is a schematic view of one embodiment of the present invention.

FIG. 2 is a schematic view of a computer network environment in which embodiments are implemented.

FIG. 3 is a block diagram of a computer node of the network of FIG. 2.

FIG. 4 is a flow diagram of tag processor member of the FIG. 1 embodiment.

### DETAILED DESCRIPTION

A description of example embodiments of the invention follows after a brief discussion of the state of the art.

Microsoft® Office 2003 SDK offers Smart Tags, which include the concept of “smart tags,” which are “hidden pointers implemented inside a document, spreadsheet, or e-mail message. Text tagged with these hidden pointers appears with a dotted underline so that one knows the text is of special interest. The hidden pointers are not displayed on screen, but if they were, they could be represented as a pair of XML tags surrounding [ones] text . . . ” Within the general class of Smart Tags are “temporary tags” and “expiring tags.” These are concepts for an SDK, not a user interface. However, smart tags in general affect the user experience, so Applicants discuss them in some detail here.

According to the SDK documentation, Temporary smart tags are smart tags that are active when the document is open, but are not saved with the document. One can implement this type of smart tag in scenarios where it is inappropriate to save certain kinds of smart tags with a document.

In Microsoft® Office 2003, smart tags can be marked to expire at a certain date and time. This saves developers maintenance and cleanup work. For example, a smart tag that links to an online coupon can be set to expire when the coupon is no longer valid.

In Microsoft® Office XP, there are situations in which the smart tag infrastructure retains smart tags that recognizer authors might not want to be retained. For example, smart tags that recognize client names run the risk of misinterpreting the user's intent if he or she enters similar client names, such as “Smith Auto” and “Smith Auto Body.” In this scenario, if the user were to pause after typing “Smith Auto,” the recognizer would initialize the discovery of a real client, but if the user finished typing the full name, “Smith Auto Body,” the original recognition would persist and not represent the actual context.

In Applicants' view, the above concepts have “surface” similarity to the present invention, but there are major differences between the Microsoft® Office SDK and the present invention. First, the Microsoft method is programmatic, whereas Applicants' method is done by the end-user. More significantly, the Microsoft method creates “recognizers” that highlight words in a document, whereas Applicants' method is part of creating social tags and (optionally) bookmarks, which can be directly specified and searched by the end-user. The Microsoft method requires development-time specification by a developer of each tag and the rules for its recognizer specification. Whereas Applicants' method provides for end-user specification of the tag and its behavior (e.g., expiring or morphing). Thus, the present invention is believed to be novel and unobvious with respect to the Microsoft® SDK, despite the superficial similarities of language.

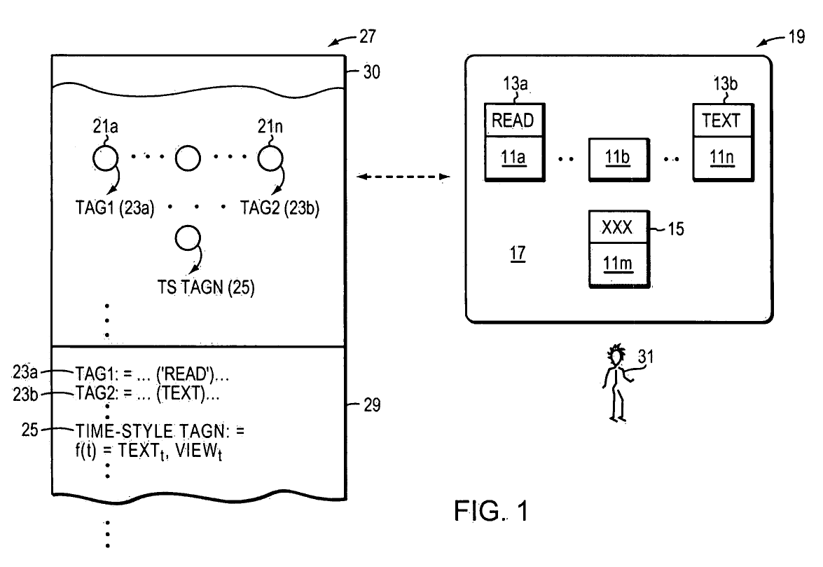

Illustrated in FIG. 1 is a user interactive environment 100 with social tagging subsystem 29 embodying the present invention. The user interactive environment may be an online portal, a social portal in a global computer network, or the like (generally 50, 60 in FIG. 1). A graphical user interface (GUI) 17 displays various items 11a, b . . . n in user interactive screen views 19 and enables users 31 to interact with these items. Example operations effected by user interaction include moving, copying, selecting, sizing, deleting items, etc. Other operations are suitable. Each item 11 is supported or otherwise implemented by a respective program object 21 or similar programming structure with operations and methods or procedures (generally computer processor routines). Common object oriented programming constructs or similar constructs and GUI display techniques are employed.

In the illustrated embodiment, an engine 27 with one or more subsystems (processing modules or processor members) 29, 30 supports the operations and is responsive to user interaction (command/requests). In particular, there is a display member/subsystem 30 rendering and refreshing screen views 19. And there is a book marking and tagging subsystem 29 that enables a user to generate (i.e. create and directly specify) social tags 13, 15 corresponding to respective items 11. Social tags 13 are of the type common in the art while tags 15 are time-style social tags of the present invention. Known or common book marking and social tagging techniques are initially and generally employed to implement tagging subsystem 29 in part and tags 13. Further implementation of time-style tags 15 is made clear below.

Each tag 13, 15 is also supported by a respective program object 23, 25 with corresponding methods or procedures (processor routines). Tag objects 23, 25 store, reference or otherwise link to respective text to be displayed with the tag 13, 15. For example, with reference to FIG. 1, tag 13a recites “Read” and is operatively coupled to item 11a in screen view 19. Program object 21a supports/implements item 11a in screen views 19 while programming tag object 23a supports tag 13a. In particular tag object 23a defines or otherwise sets forth the static text for corresponding tag 13a as illustrated by parameter value ‘Read’ between parenthesis.

In addition, the present invention improves upon or adds to (extends) the general social tagging subsystem by providing time style (time sensitive) tags 15, i.e. tags that operate as a function of time. The times style tags 15 have a user defined time dependent characteristic (or triggering event) that may be implemented by rules, scripts or similar code, executed by the respective supporting tag object 25 and social tagging subsystem/member 29.

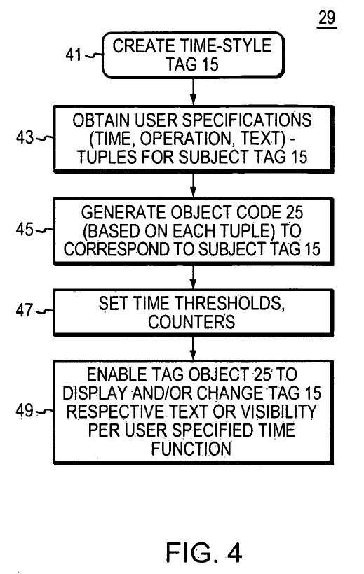

In particular, responsive to user command to create or otherwise use a time style tag 15, tagging subsystem/member 29 performs processor routine of FIG. 4. The tagging subsystem/member 29 initiates time-style tag 15 creation (Step 41) and prompts the user to specify a time and an operation in addition to specifying respective display text of the subject tag 15. Zero, one or more text for the subject tag 15 per time and operation factor pair may be specified. Step 43 of FIG. 4 is illustrative showing that the user specified time factor, operation and any pertinent text forms respective data tuples. The time factor may be specified as a certain date/time, as a time period or interval (such as an interval from now to begin display of tag text, length of time that the tag text is to be displayed, and so on) or a relative date/time (e.g., 5 days before Holiday X). Other time indications/specifications are suitable. The user specified operation may be “expire” the tag 15, “morph” the tag 15 by changing text and/or visibility, have the tag 15 “appear” and similar operations to change the subject tag 15 in displayed text and/or view (visibility) over time.

In response, subsystem 29 (steps 45, 47 in FIG. 4) generates corresponding tag object 25 code and initializes time thresholds, counters and the like. For each user, specified time factor and operation pair, the generated tag object code 25 changes tag 15 text and/or visibility (appearance, disappearance), in screen displays 19, according to user specification (Step 49, FIG. 4). For example, depending on user specified operation, the invention tagging subsystems/member 29 produces object code 25 for generating the appropriately timed text for and/or visibility of the subject tag 15. If the user specifies the “appear” operation with time=t₁ and respective text₁, subsystem 29 produces object code 25 for generating text₁ of tag 15 to display in view (be visible) beginning at t₁. If the user specified the “morph” operation for the subject tag 15 and time=t₂ with text₂ for the subject tag 15, subsystem 29 produces object code 25 for changing tag text₁ to read as text₂ at time t₂. If the user specifies the “disappear” operation with time=t₃ for the subject tag 15, subsystem 29 produces object code 25 for effectively disabling or otherwise expiring (removing) view of tag 15 at t₃. In some embodiments, this is accomplished by changing text of the tag 15 to be a null value at t₃.

In this way, the present invention enables social tags and/or bookmarks 15 to be time (or trigger event) sensitive and automatically change in user defined text and/or visibility over time, i.e., as a function of time (or event). Although this description uses the term “tags”, bookmarks, ear markings and similar user generated (directly specified by the user and not programmatically specified/generated) implements that effectively serve as a note or indicator coupled to or otherwise corresponding to an item for display are included.

Non-limiting examples of the invention time style tags 15 and example embodiments of the present invention are provided in the following Cases 1 through 4. Cases 1 through 4 are intended to be illustrations and not limitations of the present inventions features, operations and configurations.

Case 1: A user 31 tags something (an item 11) as “hot” or “au courant” or even “to read”. A month later, the items 11 that the user tagged “hot” are no longer as important. The user at that later time does not want to find and fix all such outdated “hot” tags. Instead, when the user originally adds the “hot” tags, the invention enables the user 31 in one embodiment to:

Set (or auto set) an expiring tag—i.e., the tag 15 has an expiration, so that “hot” tags disappear from screen view 19 after a user specified time interval or at a user specified date/time.

Case 2: Rather than having the tags 15 disappear from view, the user 31 would like them to reset to a different sense of urgency after a certain amount of time. In this case, an embodiment of the invention enables the user to:

Set (or auto set) a morphing tag—i.e., the tag 15 respective text transforms from one user specified value to another at a user-specified time interval (triggered by time periods, date or some other specified event).

For non-limiting example, suppose the user 31 set a morphing tag 15 as “hot” because it is related to a deadline, several days from now. Three days before the deadline, the tag 15 respective text morphs from “hot” to “URGENT” and then, once the deadline date has passed, the tag 15 morphs again to “deadline-expired.”

In another non-limiting version, the morphing tag 15 is conceptually (or in program support design) divided into two portions—a root-tag and a suffix. The root-tag does not change, but the suffix morphs. An HR (Human Resources) department might track changes in labor law with a root-tag of “laborlaw” and a suffix that changes, such as “laborlaw-breakingnews” which could change (after a user-specified time interval) to “laborlaw-recentnews” and still later into “laborlaw” without any suffix.

Case 3: The user 31 wants to mark some bookmarks as relevant to a new project, but the project has not been announced yet, and the user does not want to reveal the project name. The user could come back later and add the project name as a tag, but the user does not want to take the extra time, or might forget. An embodiment of the present invention enables the user to:

Set an appearing tag. The user 31 picks the object item 11 to be tagged and specifies (i) the subject “future” tag 15 text, and (ii) when (time frame) the tag 15 should be made visible.

Case 4: The user has one or more tags that are “private” tags, i.e. visible only to him, but wants them to be made public at some point. Conversely, the user has public tags that he wants to make private at some moment in time.

The present invention enables the user to:

Configure the tags 15 as to-public or to-private tags. At the user-specified time (or triggering event such as end of week, beginning of month, etc.), the invention system 100 makes private tags 15 become visible to others and hides the public tags 15 from others' view according to user specification.

Target times for the changes detailed above can be specified as:

some interval of time from now; and

a particular date-time (date/time certain).

Additionally, the time interval could be user-specific, site-specific, policy specific, etc.

The time interval could be determined by a set of pre-defined tags 15 with “hotness”—e.g., “hot for today” vs. “hot for a week” vs. “hot for a month” vs. “hot forever” (unlikely).

The expiration could be set in relation to another tag or bookmark 15, e.g., as long as “X” is hot, “Y” is hot; Y goes away (disappears from view) when X goes away (disappears from view).

Some tags 15 can be established as “auto set” tags. That is, they have pre-assigned expiration intervals or date-times (as determined by the above).

An additional embodiment allows the user to define additional changes for each type. For example, the user may specify a morphing tag 15 that, at the first specified time, changes to a second tag text. At a second user-specified time, the tag 15 changes to the next specified tag text (which could be the original), and so forth. Expiring tags 15 may be restored, appearing tags may expire, and so on.

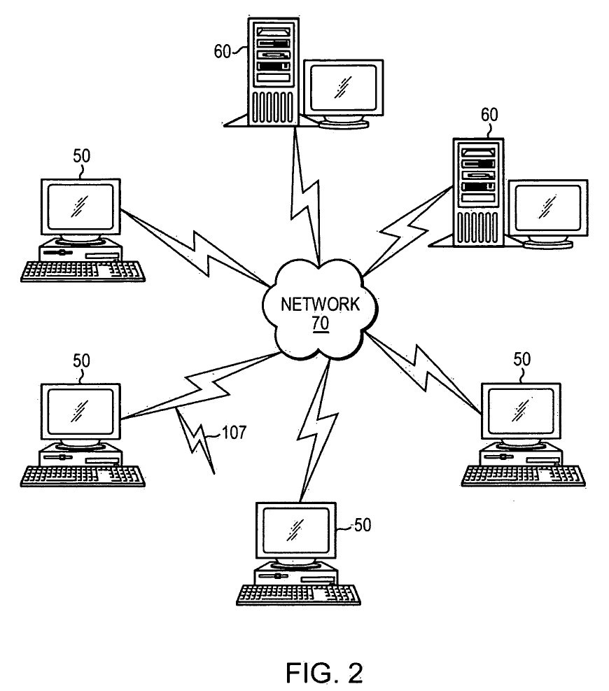

FIG. 2 illustrates a computer network or similar digital processing environment in which the present invention may be implemented.

Client computer(s)/devices 50 and server computer(s) 60 provide processing, storage, and input/output devices executing application programs and the like. Client computer(s)/devices 50 can also be linked through communications network 70 to other computing devices, including other client devices/processes 50 and server computer(s) 60. Communications network 70 can be part of a remote access network, a global network (e.g., the Internet), a worldwide collection of computers, Local area or Wide area networks, and gateways that currently use respective protocols (TCP/IP, Bluetooth, etc.) to communicate with one another. Other electronic device/computer network architectures are suitable.

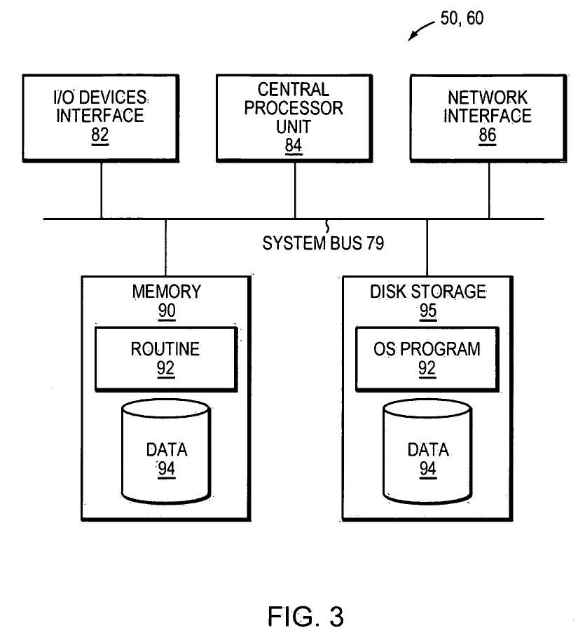

FIG. 3 is a diagram of the internal structure of a computer (e.g., client processor/device 50 or server computers 60) in the computer system of FIG. 2. Each computer 50, 60 contains system bus 79, where a bus is a set of hardware lines used for data transfer among the components of a computer or processing system. Bus 79 is essentially a shared conduit that connects different elements of a computer system (e.g., processor, disk storage, memory, input/output ports, network ports, etc.) that enables the transfer of information between the elements. Attached to system bus 79 is I/O device interface 82 for connecting various input and output devices (e.g., keyboard, mouse, displays, printers, speakers, etc.) to the computer 50, 60. Network interface 86 allows the computer to connect to various other devices attached to a network (e.g., network 70 of FIG. 2). Memory 90 provides volatile storage for computer software instructions 92 and data 94 used to implement an embodiment of the present invention (e.g., social tagging module 29, time-style tags 15 and supporting tag objects 25 detailed above). Disk storage 95 provides non-volatile storage for computer software instructions 92 and data 94 used to implement an embodiment of the present invention. Central processor unit 84 is also attached to system bus 79 and provides for the execution of computer instructions.

In one embodiment, the processor routines 92 and data 94 are a computer program product (generally referenced 92), including a computer readable medium (e.g., a removable storage medium such as one or more DVD-ROM's, CD-ROM's, diskettes, tapes, etc.) that provides at least a portion of the software instructions for the invention system. Computer program product 92 can be installed by any suitable software installation procedure, as is well known in the art. In another embodiment, at least a portion of the software instructions may also be downloaded over a cable, communication and/or wireless connection. In other embodiments, the invention programs are a computer program propagated signal product 107 embodied on a propagated signal on a propagation medium (e.g., a radio wave, an infrared wave, a laser wave, a sound wave, or an electrical wave propagated over a global network such as the Internet, or other network(s)). Such carrier medium or signals provide at least a portion of the software instructions for the present invention routines/program 92.

In alternate embodiments, the propagated signal is an analog carrier wave or digital signal carried on the propagated medium. For example, the propagated signal may be a digitized signal propagated over a global network (e.g., the Internet), a telecommunications network, or other network. In one embodiment, the propagated signal is a signal that is transmitted over the propagation medium over a period of time, such as the instructions for a software application sent in packets over a network over a period of milliseconds, seconds, minutes, or longer. In another embodiment, the computer readable medium of computer program product 92 is a propagation medium that the computer system 50 may receive and read, such as by receiving the propagation medium and identifying a propagated signal embodied in the propagation medium, as described above for computer program propagated signal product.

Generally speaking, the term “carrier medium” or transient carrier encompasses the foregoing transient signals, propagated signals, propagated medium, storage medium and the like.

As will be appreciated by one skilled in the art, the present invention may be embodied as a system, method or computer program product. Accordingly, the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, the present invention may take the form of a computer program product embodied in any tangible medium of expression having computer-usable program code embodies in the medium.

Any combination of one or more usable or computer readable medium(s) may be utilized. The computer-usable or computer-readable medium may be, for example, but not limited to, an electronic, magnetic, optical, electromagnetic, infrared, or semiconductor system, apparatus, device, or propagation medium. More specific examples (a non-exhaustive list) of the computer-readable medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a transmission media such as those supporting the Internet or an intranet, or a magnetic storage device. Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory. In the context of this document, a computer-usable or computer-readable medium may be any medium that can contain, store, communicate, propagate, or transport the program for use by or in connection with the instruction execution system, apparatus, or device. The computer-usable medium may include a propagated data signal with the computer-usable program code embodied therewith, either in baseband or as part of a carrier wave. The computer usable program code may be transmitted using any appropriate medium, including but not limited to wireless, wireline, optical fiber cable, RF, etc.

Computer program code for carrying out operations of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local are a network (LAN) or a wide area network (WAN), or the connection may be made to an external computer (for example, through the Internet using an Internet Service Provider).

The present invention is described above with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in computer-readable medium that can direct a computer or other programmable data processing apparatus to function in a particular manner, such that the instructions stored in the computer-readable medium produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operations of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures For example, two blocks shown in succession may, in fact, be executed substantially concurrently, or the blocks may sometimes be executed in the reverse order, depending upon the functionality involved. It will also be noted that each block of the block diagrams and/or flowchart illustrations, and combinations of blocks in the block diagrams and/or flowchart illustration, can be implemented by special purpose hardware-based systems that perform the specified functions or acts, or combinations of special purpose hardware and computer instructions.

While this invention has been particularly shown and described with references to example embodiments thereof, it will be understood by those skilled in the art that various changes in form and details may be made therein without departing from the scope of the invention encompassed by the appended claims.

What is claimed is:

1. A social tagging computer method comprising:
enabling display of social tags in screen views;
generating respective text of certain ones of the social tags in the screen views as a function of user specified time, wherein the certain tags are user defined and the respective text are user specified.

2. A method as claimed in claim 1, wherein the certain tags are time style tags, and respective text includes different text for different user-specified times.

3. A method as claimed in claim 2, wherein one of the different texts is a null value, such that a respective time style tag effectively disappears from screen view.

4. A method as claimed in claim 1, wherein the user specified time is a certain date/time, a time interval after which to begin display of a subject tag, a time interval during which to display the subject tag, a relative date/time and a preassigned time per respective text.

5. A method as claimed in claim 4, wherein the preassigned time is any of a given day, a week, a certain day of the week, a month.

6. A method as claimed in claim 4, wherein relative date/time is relative to another tag.

7. A method as claimed in claim 1, wherein the user specified time is a period of time; and
further displaying respective text of a certain tag for duration of the period of time and then stopping display of the respective text.

8. A method as claimed in claim 1, wherein the generating respective text of certain ones of the social tags in the screen views as a function of user specified time, includes enabling a user to effectively change display of respective text of the certain tag from a first text to a second text at user specified times.

9. A method as claimed in claim 1, wherein the respective text of at least one of the certain tags is formed of a root portion and a suffix portion, the suffix portion changing as a user specified function of time.

10. A method as claimed in claim 1, wherein each of the certain tags is effectively any one or combination of an expiring tag, a morphing tag, and an appearing tag.

11. A method as claimed in claim 1, further comprising the step of:
enabling a user to change visibility, in screen views, of respective text of at least one of the certain tags at user specified times.

12. A computer social tagging system, comprising:
a display member providing display of social tags in screen views; and
a processor member generating respective text of certain tags in the screen views as a function of user specified time, wherein the certain tags are user defined and the respective text are user specified.

13. A computer system as claimed in claim 12, wherein the certain tags are time-style tags, and the respective text includes different text for different times.

14. A computer system as claimed in claim 13, wherein one of the different text is a null value, such that a respective time-style tag effectively disappears from screen view.

15. A computer system as claimed in claim 12, wherein the user specified time is a certain date/time, a time interval after which to begin display of a subject tag, a time interval during which to display the subject tag, a relative date/time and a preassigned time per respective text.

16. A computer system as claimed in claim 15, the preassigned time is any of a given day, a week, a certain day of the week, a month.

17. A computer system as claimed in claim 15, wherein relative date/time is relative to another tag.

18. A computer system as claimed in claim 12, wherein the user specified time is a period of time; and
the display member displays the respective text of one of the certain tags for duration of the period of time and then stops display of the respective text.

19. A computer system as claimed in claim 12, wherein the processor member further enables a user to effectively change display of respective text of one of the certain tags from a first text to a second text at user specified times.

20. A computer system as claimed in claim 12, wherein the respective text of at least one of the certain tags is formed of a root portion and a suffix portion, the suffix portion changing as a function of time as specified by a user.

21. A computer system as claimed in claim 12, wherein each of the certain tags effectively is any one or combination of an expiring tag, a morphing tag, and an appearing tag.

22. A computer system as claimed in claim 12, wherein the processor member further enables a user to change visibility in screen views of a respective text of at least one of the certain tags at user specified times.

23. A computer program product for automatically changing social tags, the computer program product comprising:
a computer usable medium having computer usable program code embodied therewith, the computer usable program code comprising computer usable program code configured to:
display social tags in screen views; and
generate respective text of certain tags in the screen views as a function of user specified time.
